(19) United States
(12) Patent Application Publication
(10) Pub. No.: US 2011/0160090 A1
(43) Pub. Date: Jun. 30, 2011

(54) Nanocrystal-Based Lateral Flow Microarrays and Low-Voltage Signal Detection Systems

(75) Inventor: Robert B. Cary, Santa Fe, NM (US)

(73) Assignee: LOS ALAMOS NATIONAL LABORATORY, LOS ALAMOS, NM (US)

(21) Appl. No.: 12/991,418

(22) PCT Filed: May 5, 2009
(86) PCT No.: PCT/US09/02802

§ 371 Date: Jan. 31, 2011

Related U.S. Application Data
(60) Provisional application No. 61/126,640, filed on May 5, 2008.

(51) Int. Cl. C40B 40/06; C40B 60/12

(52) U.S. Cl. 506/16; 506/39

(57) ABSTRACT

The invention provides semiconductor nanocrystal-based lateral flow microarrays (SN-LFM), assays using SN-LFM, signal amplification strategies, optical detection devices for collecting data from SN-LFM assays, and integrated sample-to-answer SN-LFM assay/detection devices.

### RELATED APPLICATIONS

This application claims priority to U.S. Provisional Application No. 61/126,640, filed May 5, 2008.

### STATEMENT AS TO RIGHTS TO INVENTIONS MADE UNDER FEDERALLY SPONSORED RESEARCH OR DEVELOPMENT

This invention was made with government support under Contract No. DE-AC52-06NA25396, awarded by the United States Department of Energy. The government has certain rights in this invention.

### BACKGROUND OF THE INVENTION

Nucleic acid-based assays offer sensitivity, specificity and resolution. However, they are relatively elaborate and often costly, limiting their utility for point-of-care diagnostics and deployment under field conditions where a supporting laboratory infrastructure is limited or absent. Reliance upon polymerase chain reaction (PCR) and fluorescent detection of amplified nucleic acids has contributed significantly to the complexity and cost of nucleic acid diagnostics (2,4-6). Therefore, retaining assay sensitivity, while circumventing requirements for thermocyclers and fluorescence detection hardware, remains a significant challenge.

The recent advent of DNA microarray technology has promised to increase the information capacity of nucleic acid diagnostics and enable the highly multiplexed detection of genetic signatures (7). The potential of DNA microarrays to detect, in parallel, large panels of distinct nucleic acid sequences has proven to be a powerful technique for many laboratory applications (for review see (8)). Nonetheless, the reliance of this technology on costly instrumentation for high-resolution fluorescence signal transduction severely limits the utility of microarrays for field applications where a laboratory infrastructure is limited or unavailable. Additionally, the long hybridization incubations required for microarray assays increase sample-to-answer times beyond what would be acceptable for a rapid screening assay. Though microarray hybridization times as short as 500 seconds have been reported (9), such methods employ relatively elaborate microfluidic designs that remain reliant upon fluorescent detection and do not address the need for low cost, easily manufactured devices that can be used without costly supporting instrumentation.

In contrast to DNA-based assays, immunoassays have found widespread acceptance in low cost, easily used formats, perhaps the most notable of which is the chromatographic lateral flow immunoassay (for a review see (10)). Lateral flow assays, also known as hand-held assays or dipstick assays, are used for a broad range of applications where rapid antigen detection is required in an easily used, low cost format. Expanding the domain of lateral flow chromatography to nucleic acid detection, a number of recent reports have described lateral flow detection of PCR products using a variety of capture and detection schemes (11-14). Unfortunately, the utility of lateral flow detection in the context of a PCR-based assay is severely limited by the fact that reliance on thermocycling hardware largely negates the potential benefit of the otherwise highly simplified lateral flow platform. Additionally, a PCR-based approach to lateral flow detection necessitates each PCR reaction be subjected to post-amplification manipulations required to generate single-stranded products for hybridization-based detection.

Recent work has sought to alleviate reliance on PCR through employing isothermal nucleic acid amplification schemes or direct detection of unamplified genetic material. Enabled by the use of up-converting phosphor reporters, unamplified Streptococcus pneumoniae DNA sequence has been detected using a lateral flow assay format (15). Up-converting phosphor technology, while sensitive, remains dependent upon the hardware required to detect phosphor emission (16). The use of simple colorimetric detection schemes that circumvent the requirements for complex instrumentation require an upstream amplification strategy to attain suitable sensitivity. Isothermal nucleic acid amplification coupled with lateral flow detection has been reported for assays making use of cycling probe technology (CPT, (17)) and nucleic acid sequence-based amplification (NASBA, (18-20)) (21-25). While the work by Fong et al (21) made use of a lateral flow immuno-assay for DNA detection, the RNA targets amplified by NASBA in the work from Baeumner's group (22-25) were detected using a lateral flow system enabled by the use of liposome encapsulated dye and a sandwich hybridization assay similar to that reported by Rule et al (12). While shown to display nanomolar sensitivity, the reported dye encapsulating liposome-based methods require additional washing steps and the liposomes are relatively labile, must be custom synthesized, and stored under stabilizing hydrated conditions (26).

The Lateral Flow Microarray, or LFM, is a recently described miniaturized lateral flow-based platform for multiplexed nucleic acid detection (Carter, D. J. and R. B. Cary, Lateral flow microarrays: a novel platform for rapid nucleic acid detection based on miniaturized lateral flow chromatography. Nucleic Acids Res, 2007. 35(10): p. e74). The combination of reduced surface area, convective fluid movement through the lateral flow substrate, and the open-ended pores of the LFM membranes result in superior chromatography performance compared to bead-based column chromatography. Consequently, LFM provides hybridization-based detection of as little as 250 amol of analyte in 2 minutes, more rapid than reported for arrays making use of complex fluidic systems to facilitate hybridization (Peytavi, R., F. R. Raymond, D. Gagne, F. J. Picard, G. Jia, J. Zoval, M. Madou, K. Boissinot, M. Boissinot, L. Bissonnette, M. Ouellette, and M. G. Bergeron, Microfluidic device for rapid (<15 min) automated microarray hybridization. Clin Chem, 2005. 51(10): p. 1836-1844; Wei, C. W., J. Y. Cheng, C. T. Huang, M. H. Yen, and T. H. Young, Using a microfluidic device for 1 microl DNA microarray hybridization in 500 s. Nucleic Acids Res, 2005. 33(8): p. e78). The LFM platform has been used to develop a rapid assay for Bacillus anthracis, the causative agent of anthrax, and has been shown to detect RNA from as few as 2-3 B. anthracis cells when present in a complex nucleic acid background consisting of 1 μg of total human RNA (Carter and Cary, 2007, supra).

### SUMMARY OF THE INVENTION

The invention provides semiconductor nanocrystal-based lateral flow microarrays (“SN-LFM”) and related systems. SN-LFM offers improved signal amplification and increased sensitivity, and may allow for nucleic acid assays having substantially reduced or eliminated amplification requirements.

In one aspect, a SN-LFM device for detecting the presence of at least one single-stranded target nucleic acid analyte in a fluid sample is provided, comprising a chromatographic test strip which comprises (a) a sample receiving zone for receiving an aliquot of the sample and for receiving a labeled detection oligonucleotide, which detection oligonucleotide comprises a sequence which is complementary to a first sequence of the target nucleic acid; and, (b) a capture zone in lateral flow contact with the sample receiving zone, said capture zone comprising a microporous membrane, onto which at least one capture oligonucleotide is immobilized at a feature size of 500 μm diameter or smaller, and which comprises a sequence which is complementary to a second sequence of the target nucleic acid. In some embodiments, the microporous membrane is 3 mm or less in width. The lateral flow chromatographic device may combine the sample receiving zone and the capture zone, such that they comprise a contiguous microporous membrane. The microporous membrane is a lateral flow compatible nitrocellulose membrane having a pore size of between 0.2 and 20 μm. The detection oligonucleotide is labeled with a semiconductor nanocrystal. In some embodiments, the detection oligonucleotide comprises a first portion having a sequence complementary to a part of the target sequence and a second portion having a non-target specific sequence of at least 9 nucleotides, which second portion is adjacent to the label. The second portion may, for example, be a poly (A) or poly (T) sequence of at least 9 nucleotides.

In some embodiments, the first sequence and second sequence of the target nucleic acid are adjacent within 2 bases, in order to take advantage of “base stacking” hybridization stability.

In another aspect, the invention provides an SN-LFM device for detecting the presence of at least one single-stranded target nucleic acid analyte in a fluid sample, comprising a lateral flow matrix which defines a flow path and which comprises in series: (a) a sample receiving zone for receiving an aliquot of a fluid sample; (b) a labeling zone in lateral flow contact with said sample receiving zone, wherein the labeling zone comprises a porous material containing at least one detection oligonucleotide reversibly bound thereto, which detection oligonucleotide is complementary to a first sequence of the target nucleic acid and is coupled to a semiconductor nanocrystal label; and, (c) a capture zone in lateral flow contact with said labeling zone, said capture zone comprising a microporous membrane, onto which at least one capture oligonucleotide is immobilized at a feature size of 500 μm diameter or smaller. In some embodiments, the microporous membrane is 3 mm or less in width. The lateral flow chromatographic device may combine the sample receiving zone and the capture zone, such that they comprise a contiguous microporous membrane. The microporous membrane is a lateral flow compatible nitrocellulose membrane having a pore size of between 0.2 and 20 μm. The detection oligonucleotide is labeled with a detectable semiconductor nanocrystal particle. In some embodiments, the detection oligonucleotide comprises a first portion having a sequence complementary to a part of the target sequence and a second portion having a non-target specific sequence of at least 9 nucleotides, which second portion is adjacent to the label. The second portion may, for example, be a poly (A) or poly (T) sequence of at least 9 nucleotides.

In some embodiments, the first sequence and second sequence of the target nucleic acid are adjacent within 2 bases, in order to take advantage of “base stacking” hybridization stability.

In some embodiments, the SN-LFM devices of the invention employ a signal amplification strategy which utilizes multiply biotinylated DNA denrimers to carry the detection oligonucleotide, combined with streptavidin coated semiconductor nanocrystals for signal generation. In this approach, the biotin-labeled denrimers couple with the analyte nucleic acid via hybridization to the detection oligonucleotide. The streptavidin coated semiconductor nanocrystals couple to the detection oligonucleotide-analyte nucleic acid complex via biotin-streptavidin binding, brining multiple nanocrystal labels into detectable contact with single detection oliginucleotide-analyte nucleic acid complexes, resulting in substantially amplified signal.

The invention also provides a low cost and highly simplified signal acquisition system for use in conjunction with SN-LFM. Exploiting the large Stokes shift of semiconductor nanocrystals, the SN-LFM detection device of the invention employs a low voltage, long wave length UV excitation system based on LED technology. CCD or CMOS imaging is used to provide sufficient signal-to-noise, sensitivity, and bit depth (dynamic range) to allow semi-quantitative analysis of SN-LFM hybridization events. USB power (+5V) is used to energize both the LED excitation source and the CMOS or CCD imaging element. Image data is then directly communicated via a USB interface to a PC, hand-held computer, smart phone, or similar data processing instrument. Image data may then be quantified and analyzed by an appropriate algorithm (e.g. probabilistic neural network). In one embodiment, an imaging device for collecting data from an SN-LFM assay is provided, and comprises (a) one or more UV-LEDs for exciting a semiconductor nanocrystal label used in the SN-LFM assay, (b) an electronic camera with a CCD or CMOS optical sensor for detecting the emission from the excited nanocrystals; (c) an imaging platform or surface onto which SN-LFM assay detection membranes are located; and, (d) a power and data USB interface. The imaging device may also contain USB-powered fluidic and temperature modulation elements which may be useful in integrated field-deployable nucleic acid assays.

In another aspect, the invention provides assay for detecting the presence of a target nucleic acid in a liquid sample, comprising applying or contacting the liquid sample to the sample receiving zone of the SN-LFM device of the invention, allowing the sample to transport by capillary action through the capture zone, and detecting the presence or absence of the target nucleic acid by detecting the presence of the semiconductor nanocrystal label at the relevant capture zone feature. Detection may be achieved by utilizing the SB-powered, UV-LED excitation CMOS imaging SN-LFM detection device of the invention.

### BRIEF DESCRIPTION OF THE DRAWINGS

FIG. 1. Schematic representation of signal amplification using multiply biotinylated DNA dendrimers carrying the detection probe, combined with streptavidin coated semiconductor nanocrystals in a sandwich nucleic acid hybridization assay format.

FIG. 2. Dual reporter LFM. Snapshots of a single LFM visualized under ambient lighting (A) revealing dyed microsphere colorimetric signal and under UV-LED flashlight illumination (B) revealing signal generated by fluorescent semiconductor nanocrystals (biotin conjugated Quantum Dots). The LFM membrane was challenged with dnaR89 detected using biotinylated detection oligonucleotide R-57-76-3TBIO. The detection oligonucleotide sequence is: 5′-AGGTGAGACATAATCATGCA TTTTTTTTTU-biotinTTTTU-biotinTTTTU-biotin3′.

FIG. 3. Linearity of semiconductor nanocrystal-based LFM detection. Varying quantities of dnaR89 were detected by LFM using R-57-76-3TBIO and streptavidin conjugated semiconductor nanocrystals. The resulting LFMs were quantified on an Axon GenePix 4200 Pro microarray scanner using GenePix Pro 6.0 software. Background corrected mean signal values are shown plotted versus fmols of dnaR89. The assay exhibits excellent linearity (R²=0.991) over a 1000-fold range of target.

FIG. 4. Prototypes of USB-powered, UV-LED excitation, CMOS image processing device for detecting SN-LFM signals. (A-B) an initial prototype CMOS imaging device for fluorescent nanocrystal detection was fabricated with an inexpensive web-camera affixed to an Altoid mint box, leads running from the USB voltage source to a UV-LED array, and a gelatin filer in front of the lens, which was focused. (C) Without optimizing light distribution or image collection routines the prototype SN-LFM imaging system was readily able to detect 605 nm emissions from an SN-LFM assay. (D) A commercially available USB thumb-drive camera illustrates the feasibility of incorporating a CMOS sensor into a USB thumb-drive device for LFM imaging. (E) A more refined prototype was constructed and tested as further described in Example 2. This prototype utilized a higher resolution sensor. (F) LFM challenged with 250 amol synthetic analyte (cognate features indicated with arrows) and imaged with the device depicted in part (E), top two strongly positive features are positive controls resulting from a biotin-streptavidin interaction. (G) Colorimetric LFM challenged with 250 amol synthetic analyte (arrowheads) for comparison with part (F), vertical series of features on the left are positive controls resulting from a biotin-streptavidin interaction. Further increases in sensitivity are predicted for quantum dots with emissions more closely matched to the spectral response of the image sensor. Bar is 600 μm for (C).

### DETAILED DESCRIPTION OF THE INVENTION

Unless otherwise defined, all terms of art, notations and other scientific terminology used herein are intended to have the meanings commonly understood by those of skill in the art to which this invention pertains, unless otherwise defined. In some cases, terms with commonly understood meanings are defined herein for clarity and/or for ready reference, and the inclusion of such definitions herein should not be construed to represent a substantial difference over what is generally understood in the art. The techniques and procedures described or referenced herein are generally well understood and commonly employed using conventional methodologies by those skilled in the art, such as, for example, the widely utilized molecular cloning methodologies described in Sambrook et al., Molecular Cloning: A Laboratory Manual 3rd. edition (2001) Cold Spring Harbor Laboratory Press, Cold Spring Harbor, N.Y. and Current Protocols in Molecular Biology (Ausbel et al., eds., John Wiley & Sons, Inc. 2001. As appropriate, procedures involving the use of commercially available kits and reagents are generally carried out in accordance with manufacturer defined protocols and/or parameters unless otherwise noted.

### SN-LFM System Overview

The SN-LFM devices and systems of the invention are similar to colorimetric LFM devices and systems, except that the detectable label is a fluorescent semiconductor nanocrystal, which provides improved assay sensitivity. In some embodiments, signal amplification is achieved by using multiply biotinylated DNA dendrimers carrying the detection probe, combined with streptavidin coated semiconductor nanocrystals in a sandwich nucleic acid hybridization assay format. The SN-LFM devices and systems of the invention also enable low-cost, low-power sample-to-answer assay/detection systems, such as the invention's “ThumbArray” described infra.

The invention takes advantage of the LFM platform described in Carter and Cary, 2007, Nucleic Acids Res. 35(10): e74 and in U.S. patent application Ser. No. 11/894,910 and PCT International Patent Application No. PCT/US2007/018537, which are hereby incorporated herein. LFM offers reduced reagent use, femtomole sensitivity, excellent linear dynamic range, and rapid detection. Moreover, the small feature sizes of capture oligonucleotides renders the potential information capacity of the platform comparable to more traditional spotted fluorescence microarrays as well as improving sensitivity, and provides an excellent platform for highly multiplexed assays, allowing many proteins or nucleic acids to be detected in a single assay. Coupled with an isothermal amplification technique, LFM provides a facile means of rapidly detecting nucleic acid targets while circumventing hardware requirements for fluorescence detection and PCR thermocycling.

The SN-LFM devices and systems utilize fluorescent nanoparticles or nanocrystals (e.g. Qdots, QuantumDots, Inc.) for labeling the detection oligonucleotides employed to hybridize the target nucleic acid analyte. Semiconductor nanocrystals offer superior stability characteristics in comparison to fluorescent dyes and colorimetric labels, and also enable increased sensitivity in LFM assays. Nanocrystals also possess additional attributes, making them ideal fluorescent labels, including broad excitation spectra, narrow emission spectra, precise tunability of the emission peak, longer fluorescence lifetime than organic fluorophores, and negligible photobleaching. For a review, see: Michalet et al., 2001, Properties of Fluorescent Semiconductor Nanocrystals and their Application to Biological Labeling”, Single Molecules 2(4): 261-276). See also, Buhro and Colvin, 2003, “Semiconductor nanocrystals: Shape matters”. Nature materials 2 (3): 138-9. Nanocrystals are now quite well known, in widespread use, and commercially available (i.e., Qdots® from Invitrogen, Carlsbad, Calif.; EviDots from Ocean Optics, Dunedin, Fla.; evidots and related products form Evident Technologies, Troy, N.Y.). Protocols for conjugating nanocrystals to biological molecules, such as streptavidin, are also know in the art.

SN-LFM signals may be detected using any of a number of ultraviolet light sources including hand held UV lamps, UV emitting LEDs, and light sources with sufficient emission in the UV to excite the nanoparticles. A simple filter can be used to enhance the visualization of nanoparticle fluorescence emissions. For example, a long pass filter with a cut off below the emission wavelength of the nanoparticle may be employed. In the case of excitation with a white light source, an additional filter to limit excitation to UVA and shorter wavelengths can be used (e.g., a 380 nm short pass filter).

SN-LFM offers reduced reagent use, femtomole sensitivity, excellent linear dynamic range, and rapid detection. SN-LFM shows at least a three orders of magnitude increase in linear dynamic range compared to colorimetric LFM. As demonstrated by the results described in Example 1, infra, SN-LFM achieves remarkable signal linearity over the 1 fmol to 1000 fmol range. Moreover, the small feature sizes of the capture oligonucleotides used in the assay renders the potential information capacity of the platform comparable to more traditional spotted fluorescence microarrays as well as improving sensitivity, and provides an excellent platform for highly multiplexed assays, allowing many proteins or nucleic acids to be detected in a single assay.

Coupled with an isothermal amplification technique, SN-LFM provides a facile means of rapidly detecting nucleic acid targets while circumventing hardware requirements for fluorescence detection and PCR thermocycling. SN-LFM has several advantages when compared to colorimetric LFM systems, including the ability to provide compatible detection systems, such as the invention's SN-LFM detection devices, and to combine the assay and detection systems into an easy to use, filed-deployable, sample-to-answer nucleic acid assay device, such as the invention's “ThumbArray”.

SN-LFM devices of the invention utilize sandwich-type hybridization, either employing sets of target-complementary oligonucleotides (or other nucleic acid molecules, such as dendrimers) to detect nucleic acid analytes, or binding ligands such as antibodies to detect protein analytes. In respect of nucleic acid detection methods using LFM, nucleic acid target is detected redundantly using (a) semiconductor nanocrystal-labeled detection oligonucleotides complementary to one of two signature sequences on the target nucleic acid, and (b) membrane-immobilized capture oligonucleotides complementary to the other signature sequence on the target. In the practice of a nucleic acid detection assay utilizing the SN-LFM system of the invention, the capture of amplified target nucleic acids by the membrane-immobilized capture oligonucleotides and labeled detection oligonucleotides brings the label into contact with the membrane, displaying an optically-readable signal. Thus, the assay requires positive hybridization to two distinct sequences on the target nucleic acid in order to produce a localized signal, resulting in very high assay specificity.

LFMs offer several advantages arising directly from the miniaturization of the system without sacrificing detection sensitivity. While traditional lateral flow assays make use of sample volumes on the order of hundreds of microliters to milliliters, the miniaturization approach embodied in the invention reduces sample volume to about 10 μl. This reduced sample volume significantly decreases the consumption of reagents required for amplification, and thus assay cost.

### SN-LFM Detection Device Overview

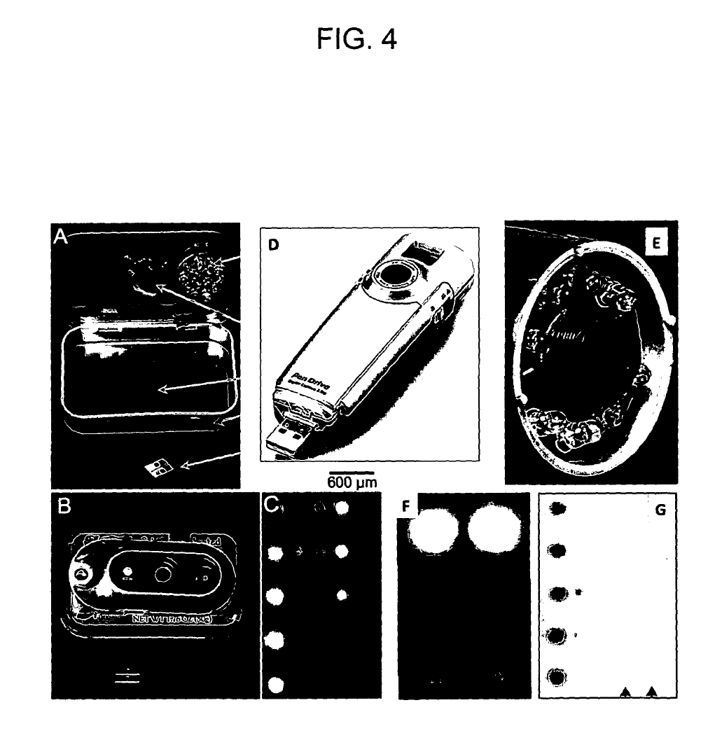

In a complementary aspect of the invention, a low-cost, low-power optical imaging device is provided for detecting and processing data from an SN-LFM assay. In one embodiment, an imaging device for collecting data from an SN-LFM assay is provided, and comprises (a) one or more UV-LEDs for exciting a semiconductor nanocrystal label used in the SN-LFM assay, (b) an electronic camera with a CCD or CMOS optical sensor for detecting the emission from the excited nanocrystals; (c) an imaging platform or surface onto which SN-LFM assay detection membranes are located; and, (d) a power and data USB interface. Another embodiment further comprises a solid state data storage chip, such as a Flash memory chip, to store data collected by the imaging element. Another embodiment further comprises USB-powered fluidic and/or temperature modulation elements. Additionally, a long pass or band pass optical filter may be used in front of the camera lens in order to reduce light contamination from the excitation source, such as the deep yellow filter used in the prototype device described in Example 2, infra. A prototype device is shown in FIG. 4 (A-B), and SN-LFM detection using the device is shown in FIG. 4 (C-F).

In another embodiment, the imaging device further comprises the SN-LFM device used to run the nucleic acid assay, thus providing a sample-to-answer SN-LFM nucleic acid assay. Envisioned in a form factor similar to USB memory drives used in conjunction with personal computing devices, the “ThumbDrive” of the invention combines the SN-LFM assay device with the SN-LFM detection device, to produce an integrated assay device. In some embodiments, this combined device will include a sample receiving zone, a labeling zone and a capture zone, thereby providing a single device used for conducting the LFM assay and detecting the results. In other embodiments, where nanocrystal labeling is achieved prior to or concurrent with sample addition, the combined device will include the sample and capture zones, but not a labeling zone.

The device may be configured to provide illumination of the SN-LFM in either epi or trans. Illumination in trans allows significant simplification of the optical system by direct physical juxtaposition of the microarray substrate with the imaging chip surface Close physical proximity of the microarray with the imaging chip allows signal intensity to be measured with no intervening optics. For some applications, however, epi illumination is preferable, and in this configuration, the device may include a simple optical element to assure adequate signal collection.

Further embodiments include a combination of the imaging device, or the combined SN-LFM assay and imaging devices, with a computerized data processing device, such as a computer, smart phone or other processing instrumentation used for quantifying and analyzing the SN-LFM results transmitted via the USB data interface.

This aspect of the invention is further described by way of Example 2, infra, which describes the construction of a prototype CMOS-based imaging device used to detect SN-LFM signals. In this prototype device, a low cost “web cam” CMOS imager with 8-bit color depth was employed. While the dynamic range of this prototype was limited by its 8-bit color depth, higher resolution imagers may be employed depending upon the nature of the assay it is intended to detect. In applications such as gene expression analysis, which depend upon semi-quantitative data collection, 12-bit grayscale CMOS imaging devices, or similar, will allow expanded signal level differentiation. For example, the use of a 12-bit grayscale CMOS imager chip in the prototype device of Example 2 would allow 4096 signal levels to be distinguished with only a modest increase in materials cost.

### Physical Components of SN-LFM Devices

The SN-LFM devices of the invention comprise a series of absorbent substrates which are used to transport analyte in a lateral manner to components containing certain reagents or materials required for the detection of the analyte.

In one aspect, a lateral flow chromatographic device of the invention comprises a chromatographic test strip which comprises (a) a sample receiving zone for receiving an aliquot of the sample and for receiving a labeled detection oligonucleotide, which detection oligonucleotide comprises a sequence which is complementary to a first sequence of the target nucleic acid; and, (b) a capture zone in lateral flow contact with the sample receiving zone, said capture zone comprising a microporous membrane, onto which at least one capture oligonucleotide is immobilized and which comprises a sequence which is complementary to a second sequence of the target nucleic acid. In an alternative embodiment, a labeling zone in lateral flow contact with said sample receiving zone is inserted up-stream of the capture zone and is lateral flow contact with the capture zone. A labeling zone comprises a porous material containing at least one detection oligonucleotide reversibly bound thereto, which detection oligonucleotide is complementary to a first sequence of the target nucleic acid and is coupled to a semiconductor nanocrystal label, thereby enabling the label step to take place on the device.

In a simplified illustration, one embodiment of an SN-LFM device is structurally organized into at least 3 zones, comprising in linear orientation: (a) a sample pad constructed from absorbent material onto which a liquid, nucleic acid-containing sample is deposited, (b) a conjugate release pad containing a least one oligonucleotide-fitted semiconductor nanocrystal, and (c) a detection zone comprising a nitrocellulose or nylon membrane containing at least one immobilized capture oligonucleotide. In some embodiments, a fourth element comprises an absorbent material which is capable of facilitating the lateral flow of the liquid sample from the sample pad end of the device to and through the detection zone. In some embodiments, the sample pad (a) and the conjugate release pad (b) are combined. In alternative embodiments, the conjugate release pad element is eliminated, and the sample to be assayed for the presence of a target nucleic acid is mixed with the oligonucleotide-fitted detection particle prior to placing the sample onto the sample pad.

The first substrate, or sample pad or sample receiving zone, comprises an absorbent material preferably composed of a matrix, with minimal nucleic acid binding properties, that will permit unobstructed migration of the nucleic acid analyte to subsequent stages of the apparatus without depletion. In a specific embodiment, the sample pad is composed of a cellulose fiber pad such as Millipore cellulose fiber sample pad material (Cat# CFSP223000).

In embodiments where separate sample and conjugate release pads are employed in the SN-LFM device, the sample pad is situated within the device such that it is in physical contact with the conjugate release pad.

The substrate which contains the nanocrystal-labeled detection oligonucleotide conjugate is termed the conjugate release pad or labeling zone. In some embodiments, the labeling zone is also used to receive sample directly. The conjugate release pad comprises a matrix composed of a material with minimal nucleic acid binding capacity and of a physical composition which allows dried detection particles to be liberated into solution with minimal residual binding to the matrix. Examples of materials suitable for conjugate pads include glass fiber and polyester materials (e.g., rayon). These materials are commonly available from various commercial sources (e.g., Millipore, Schleicher & Schuell).

The detection membrane of the capture zone may be any microporous membrane material which is lateral flow compatible, typically microporous cellulose or cellulose-derived materials such as nitrocellulose (e.g., HiFlow 135, Millipore) or nylon. In some embodiments, the sample receiving zone and the capture zone comprise a contiguous microporous membrane.

Typically, the microporous membrane defines a relatively narrow flow path. This may be achieved, for example, by utilizing narrow strips of microporous membrane material. Excellent results are obtained with membrane strips of 5 mm or less in width, with the best results being obtained with strips of 3 mm or less. As will be appreciated, other means for retaining a narrow flow path of less than 5 mm or less than mm may be used, and may include without limitation the use of barriers which define borders which limit the flow path to a channel.

The microporous membrane of the capture zone is a lateral flow compatible membrane such as cellulose, nitrocellulose, polyethersulfone, polyvinylidine fluoride, nylon, charge-modified nylon, and polytetrafluoroethylene. Typically, the membrane is nitrocellulose. The detection membrane is typically provided with a backing material for support, such as mylar or similar plastic materials. The membrane may be treated with agents that inhibit non-specific binding of analyte or other reagents used in an SN-LFM assay.

In embodiments utilizing nitrocellulose, pore sizes typically range between 0.2 and 20 μm, and more typically between 0.2 and 12 μm. In preferred embodiments utilizing particle labels, the pore size of the microporous membrane should be on the order to about 10 times the diameter of the particle.

In one embodiment, the detection membrane is composed of a supported nitrocellulose membrane of sufficiently large pore structure to allow the unimpeded transport of detection reagent through the membrane matrix. Examples of suitable nitrocellulose materials for dyed microsphere mediated detection are Millipore HiFlow Plus HF09004, HF13504, Schleicher & Schuell Prima 60, Schleicher & Schuell Prima 85. The Millipore HF13504 nitrocellulose membrane has been demonstrated to provide rapid, specific and sensitive detection when patterned with appropriate capture oligonucleotides. The microporous membrane is placed in lateral flow contact with the labeling zone (conjugate release pad).

In some embodiments, an absorbent material is placed in lateral flow contact with the distal end of the detection membrane in order to facilitate lateral flow through the entire SN-LFM device. Materials suitable for use as an absorbent pad include any absorbent material, including, but not limited to, nitrocellulose, cellulose esters, glass (e.g., borosilicate glass fiber), polyethersulfone, cotton, dehydrated polyacrylamide, silica gel, and polyethylene glycols. The rate of capillary flow can be controlled by choosing the appropriate absorbent zone material.

SN-LFM devices may be encased in a housing as described in, e.g., U.S. Pat. No. 5,451,504. Materials for use in the housing include, but are not limited to, transparent tape, plastic film, plastic, glass, metal and the like. Such housings preferably contain an opening or sample port for introducing sample, as well as a window(s) permitting the visualization of the detection zone(s) of the detection membrane.

A SN-LFM device may be combined with a SN-LFM detection device to create a single sample-to-answer nucleic acid assay device, as described supra and in Example 2, infra.

### SN-LFM Microarray Fabrication:

In the fabrication of an SN-LFM device, the microporous membrane of the capture zone is used for patterning capture oligonucleotides and or protein capture ligands (i.e., antibodies).

In preferred nucleic acid detection SN-LFM fabrications, capture oligonucleotides are patterned onto the detection membrane or substrate (i.e., nitrocellulose) with spot diameter sizes (“feature sizes”) of about 1 mm or less, preferably 600 μm or less, more preferably less than about 300 μm diameter, and in some embodiments, smaller (i.e., 50 to 200 μm, 50 to 250 μm, 50 to 300 μm). Oligonucleotide concentrations for spotting are generally in the range of 200 μM-800 μM. In embodiments in which PNAs or LNAs are used to synthesize oligonucleotides, lower densities may suffice.

Detection membranes may be patterned to suit the desired design of the detection element of the device. Methods for depositing nucleic acids and proteins onto microporous membranes such as nitrocellulose are well know, and negative and positive control reagents as well as capture reagents may be patterned on to the detection membrane using any of a number of deposition techniques. These techniques can be selected based on the density of information to be represented on the detection membrane. Manual deposition by pipette, automated deposition by robotics through contact mediated processes (stainless steel pins on a contact microarray printing robot) or noncontact mediated processes such as piezo responsive micropipettes, may all be used successfully to fabricate the nucleic acid detection device described here.

Preferably, when using nitrocellulose and similar membranes, non-contact printing techniques are used to deposit capture oligonucleotides or proteins onto the detection membrane, in order to retain the structural integrity of the detection membrane material.

Additionally, more convention means may be employed, including various techniques commonly used to fabricate hand held assay devices for the immunological detection of proteinaceous analytes in the context of a lateral flow immunochromatographic device.

For example, immobilization of capture oligonucleotides directly on the detection membrane may be accomplished by using high salt to adsorb the nucleic acid molecules to the surface of the membrane, combined with baking at about 80° C. to permanently fix the adsorbed oligonucleotides. Additionally, oligonucleotides may be deposited onto the membrane (i.e., nitrocellulose), air dried, and subjected to UV radiation. Capture oligonucleotides may also be fixed directly to detection membrane by vacuum transfer in the presence of an equimolar concentration of sodium chloride and sodium citrate, or by the use of ultraviolet irradiation. The capture oligonucleotides may also be covalently linked to charge-modified nylon. In other embodiments, capture oligonucleotides may incorporate a reactive ligand (e.g., biotin) and may be immobilized indirectly on the detection membrane as a result of the interaction between the ligand and an immobilized member of a binding pair (e.g., streptavidin).

Detection membranes may be patterned with positive and negative control reagents and capture reagents in an array such that the physical position of each reagent is known. Positive control reagents can be composed of oligonucleotides complementary to detection oligonucleotides immobilized on detection reagents (i.e. dyed microspheres linked to oligonucleotides through a covalent bond or through an affinity interaction such as that mediated by streptavidin/biotin interactions). Alternatively, in embodiments where the streptavidin/biotin interaction is used to couple dyed microspheres to oligonucleotides the positive control array element can be composed of biotin in any of a number of forms suitable for immobilization on nitrocellulose (for example, a biotin labeled nucleic acid). Following binding to detection oligonucleotides, free biotin binding sites on streptavidin-conjugated dyed microspheres remain available for interaction with immobilized biotin on the detection membrane, thus providing one form of positive control.

Another positive control may be achieved by the immobilization of oligonucleotide on the detection membrane. The use of an oligonucleotide complementary to the dyed microsphere-conjugated detection oligonucleotide as a positive control allows direct hybridization of the detection oligonucleotide/dyed microsphere complex following lateral flow chromatography over the positive control. Negative controls for hybridization specificity can be incorporated into the device by patterning the detection membrane with detection oligonucleotide or other nucleic acid sequences predicted, by means known to those skilled in the art, to not hybridize to the detection oligonucleotide sequence.

For nucleic acid analytes, capture reagents are composed of oligonucleotides synthesized such that the sequence is complementary to a region of the analyte target nucleic acid not overlapping with the region complementary to the detection oligonucleotide. Ideally, the predicted secondary structure of the analyte target nucleic acid is examined to identify those regions exhibiting reduced likelihood of participating in intramolecular hydrogen bonds. Such regions are preferable sites for detection and capture oligonucleotide binding.

Array elements may take the form of lines, stripes, dots or human readable icons, letters or other forms or shapes deemed useful to the interpretation of device read-out. In the case of spots or dots deposited by robotic or manual means, individual feature sizes from 50 microns to 5 mm have been shown to provide accurate and interpretable hybridization mediated detection of 20 fmol analyte DNA molecules.

### Capture and Detection Oligonucleotides:

For nucleic acid analytes, SN-LFM devices incorporate two classes of oligonucleotide referred to here as capture and detection oligonucleotides. The detection oligonucleotide is conjugated to a semiconductor nanocrystal that, when concentrated by capture through hybridization, renders the capture zone optically distinguishable from the surrounding substrate and from additional capture zones where the detection reagent has not been sequestered.

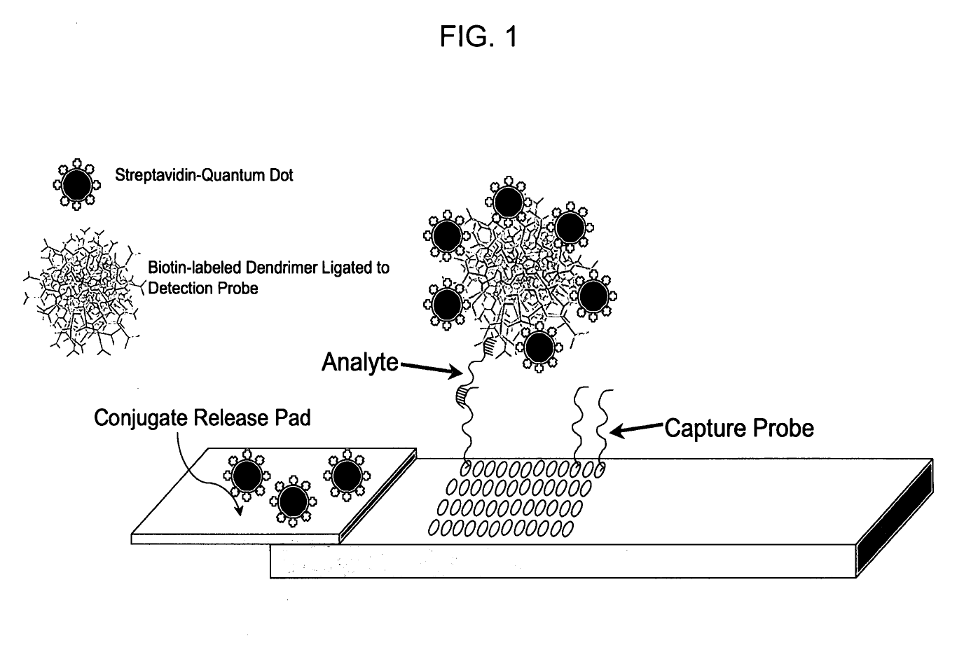

In some embodiments, a nucleic acid complex, such as a DNA dendrimer or branched-DNA molecule, carrying multiple detectable moieties, such as fluorescent molecules or biotin, can be used to amplify lateral flow microarray signal intensity. By generating DNA dendrimers carrying a detection sequence complementary to a region of the target (detection sequence) each hybridization event at the SN-LFM capture zone results in the localization of multiple detectable labels. Using a highly biotinylated dendrimer and streptavidin coated semiconductor nanocrystals (see FIG. 1), fluorescent signal amplification can be realized. The large number of streptavidin binding sites on biotinylated dendrimers will increase the number of streptavidin bound nanocrystals captured by each hybridization event and generate a correspondingly amplified signal. Several potential advantages, especially with respect to multiplexed detection, may be realized using this approach. Specifically, the use of a generic biotin/streptavidin interaction allows the simultaneous use of multiple detection probe sequences without requiring the preparation of multiple nanocrystal-detection probe conjugates. Together with the use of generic tag sequences added to amplicons through the use of specially designed NASBA primers, this approach is compatible with the development of generic tag-based SN-LFMs suitable for the detection of differing panels of pathogens without redesign of the overall layout.

The detection oligonucleotide is designed such that the melting temperature of the resulting oligonucleotide allows hybridization to its cognate sequence on the analyte under ambient conditions with sufficient rapidity to allow duplex formation to occur during lateral flow. Detection oligonucleotides with Tm of 50-70° C. have been shown to provide effective reagents for the detection of relevant analytes (using approximately 20-mer oligonucleotides).

Detection oligonucleotides are synthesized with suitable modifications to allow the efficient linkage to appropriate detection reagent. In some embodiments it is advantageous to include a spacer sequence consisting of 9 to 20 T residues proximal to the modified end of the oligonucleotide that will be coupled to the detection reagent. Chemistries of known suitability for use in the device include biotin/streptavidin through a biotin incorporated onto either the 5′ or 3′ end of the detection oligonucleotide and covalent cross-linking through a primary amine incorporated into either the 3′ of 5′ end of the detection oligonucleotide. In one preferred process, detection oligonucleotides are covalently linked to polystyrene microspheres using the coupling agent 1-etyl-3-(3-dimethylaminopropyl-diimide HCl (EDAC). Other methods that mediate the formation of a stable complex between the detection reagent and the detection oligonucleotide under assay conditions should also be suitable for use in the fabrication of the device.

The second class of oligonucleotide used in the device is the capture oligonucleotide. This reagent is immobilized on the microporous detection membrane through the use of standard methods for coupling nucleic acids to nitrocellulose or nylon, including without limitation drying followed by ultraviolet light cross-linking using 0.5 Joules UV. The capture oligonucleotide is designed such that the sequence is complementary to the analyte target nucleic acid at a region predicted to have little or no secondary structure. The length of the capture oligonucleotide is typically approximately 20 bases in length or of a length to generate a predicted melting temperature of approximately 50-70° C.

In some embodiments it may be advantageous to add a spacer sequence consisting of 9 to 20 T residues.

Detection and capture oligonucleotides can be synthesized using well known DNA synthesis chemistries. The incorporation of modified nucleic acids such as PNA (peptide nucleic acid) or LNA (locked nucleic acid) may be useful for the enhanced hybridization properties of these DNA derivatives. The use of PNA or LNA moieties in the preparation of detection and/or capture oligonucleotides will be useful in manipulating the desired melting temperature, and so may allow shorter oligonucleotides to be employed for detection and/or capture where sequence constraints preclude longer DNA oligonucleotides.

In some embodiments, detection and capture oligonucleotides are designed to hybridize to target nucleic acid within 0, 1 or 2 bases of each other, in order to increase the stability of hybridization via the “base stacking” phenomenon. Base stacking has been reported to stabilize hybridization and allow efficient capture of dilute nucleic acids by hybridization (38-42).

### SN-LFM Nucleic Acid Assays:

In one aspect of the invention, an SN-LFM assay is provided. SN-LFM assays of the invention are useful for the specific detection of a target analyte, typically from a complex sample of interest, and generally comprise the steps of extracting analyte material (i.e., DNA, RNA, protein) from sample of interest, enriching for the analyte, and detecting the presence of the analyte using an SN-LFM device populated with target-specific capture elements.

In one aspect, the invention provides a method of testing for the presence of a target nucleic acid in a liquid sample, comprising applying or contacting the liquid sample to the sample receiving zone a lateral flow chromatographic device of the invention, allowing the sample to transport by capillary action through the capture zone, and detecting the presence or absence of the target nucleic acid by detecting the presence of the label at the relevant capture zone feature.

Various DNA and RNA extraction methodologies are routine and well known in the art. Various kits for the efficient extraction of total nucleic acid, RNA or DNA are widely available from a number of commercial entities. Any of these methodologies and kits may be used to extract nucleic acid from a sample to assessed using the SN-LFM assay.

Single-stranded RNA or DNA targets may be amplified directly, while double-stranded DNA targets generally are rendered single-stranded before amplification. Methods for rendering single-stranded DNA templates from a double-stranded DNA targets include without limitation heat penetration (i.e., 95° C. for 5 minutes) and chemical denaturation (i.e., sodium hydroxide, followed by neutralization). Another method for rendering amplifiable single-stranded DNA from double-stranded DNA involves enzymatic unwinding of the double-stranded DNA, using for example a DNA helicase, which can open-up portions of the DNA, permitting primer and polymerase access and binding (see Kornberg and Baker, 1992, DNA Replication, 2nd Edition, New York: WH Freeman and Company; Caruthers and McKay, 2002, Helicase structure and mechanism. Curr Opin Struct Biol 12: 123-133).

As used herein, a “target sequence” is a nucleotide sequence within a target nucleic acid molecule which is to be amplified. Within the target sequence is a primer binding portion, to which primers are designed to hybridize in order to initiate DNA polymerization.

The selection of a particular target sequence for amplification will relate to the SN-LFM assay objectives. For example, where amplification is aimed at identifying a particular strain of an organism, the target sequence should be one of the unique genetic signatures which differentiates that strain from others to which it may be related. In some cases, this may be a single defining sequence. In other cases, a combination of target sequences may be required to reliably identify and differentiate the organism. The selection of target sequences which impart specificity to assays utilizing amplified genetic material involves considerations well known in the art, including for example, unique pathogen-specific sequences, toxins genes, virulence factors or specific signature sequence combinations.

In the practice of the invention, single or multiple target sequences may be amplified in a single reaction using suitable, specific primer oligonucleotides. When multiple target sequences are to be amplified, primers must be designed to avoid possible nonspecific interactions as is well known.

Extracted nucleic acids may be purified prior to amplification. A number of column type DNA and RNA purification devices are commercially available and may be employed for this purpose. Various other techniques for purifying DNA and RNA may be employed, including without limitation, electrophoresis, gradient separation, affinity purification, etc.

SN-LFM assays are useful for the detection of single stranded amplification products derived from samples of interest (i.e., clinical samples, environmental specimens, etc.). SN-LFM is compatible for use with virtually any nucleic acid amplification method, including PCR and isothermal amplification methods, such as NASBA. Briefly, NASBA is an RNA amplification methodology that offers several advantages over other RNA amplification methods, including the absence of a reverse transcriptase step. NASBA is an isothermal reaction performed at 41° C., which obviates the need for a thermocycler and may facilitate the production of point-of-test devices. A single-stranded antisense RNA product is produced during NASBA, which can be directly hybridized by a probe sequence to accelerate post-amplification interrogation of the product. Additionally, selection criteria for NASBA primers are less stringent than with other amplification methods, allowing easier primer design in selected less-conserved regions of the gene. Furthermore, the amplification power of NASBA has been reported to be comparable to, or sometimes even higher than that of PCR.

In this connection, the invention provides a method for detecting the presence of a target nucleic acid in a biological sample, comprising: (a) providing a biological sample suspected of containing the target nucleic acid sequence; (b) releasing nucleic acid from the biological sample; (c) amplifying the target nucleic acid using nucleic acid sequence based amplification (NASBA) to generate a solution containing amplified single-stranded RNA complementary to the target nucleic acid, if present in the extracted DNA and/or RNA from the biological sample; and, (d) assaying for the presence of the complementary RNA target nucleic acid using a SN-LFM assay of the invention.

In the SN-LFM assay progression, initially, and typically following extraction and amplification of target nucleic acid, a solution containing one or more target sequences to be detected by the device is introduced to the sample pad. This may be achieved by dipping the lateral flow device sample pad/sample receiving zone into the solution, or by dropping a quantity of the solution onto the sample pad/sample receiving zone of the lateral flow device. The device is sufficiently robust that the composition of the buffer solution carrying the target sequence(s) is not critical, however, several practical considerations are taken into account to assure compatibility of the buffer with the device. Most significantly, the ionic strength of the sample buffer must be such that precipitation or aggregation of the detection particles does not occur. Similarly, sufficient ionic strength of the buffer is required to support hybridization during lateral flow. Impregnation of the sample pad and/or conjugate release pad with Triton-X100, SDS, BSA, ficol, and/or polyvinyl pyrolidone, or introduction of these components to the sample buffer itself, can stabilize the detection particles and block non-specific interactions between the detection particles and the detection membrane. While a range of concentrations of these reagents can be used successfully, buffers of proven efficacy include 0.1% ficol, 0.1% BSA, 1% Triton X-100, and 150 mM NaCl. This particular buffer supports mono-disperse detection particle suspensions.

Additionally, buffers containing higher concentrations of Triton X-100 and SDS have been found to support higher ionic strength environments without detection particle aggregation and may be used to facilitate hybridization. For example, 3% Triton X-100, 0.1% SDS, 600 mM NaCl has been shown to support subnanomolar hybridization-based detection on the device.

Once on the sample pad/sample receiving zone, the analyte solution flows from the proximal (sample) end towards the distal (detection) end of the device. In one embodiment, semiconductor nanocrystal-labeled detection oligonucleotides are embedded into the conjugate release pad component of the device. As the analyte solution moves across the conjugate release pad, the nanocrystal-labeled detection oligonucleotide can hybridize target sequences within the sample. The resulting hybridized complex continues lateral flow migration to the detection membrane, where immobilized capture oligonucleotides hybridize to the target sequence, thus capturing the target sequence-detection oligonucleotide-nanocrystal complex, which may then be detected.

### EXAMPLES

### Example 1

### Fluorescent Semiconductor Nanocrystal-Based LFM

To assess the impact of a fluorescent reporter on the linear dynamic range of SN-LFM mediated analyte detection, a combined colorimetric and fluorescent detection scheme was devised. In this detection scheme, conjugated dyed microspheres as well as streptavidin conjugated fluorescent semiconductor nanocrystals (605 nm emission, Qdots, Invitrogen, Inc.) are used simultaneously as the reporter particles. For these experiments a detection oligonucleotide, R-57-76-3TBIO (5′-AGGTGAGACATAATCATGCATTTTTTTTTU-biotinTTTTU-biotinTTTTU-biotin3′), carrying three biotin-modified nucleotides was employed in hybridization sandwich assays. Following lateral flow of 250 amol of synthetic analyte dnaR89 in 10 μl of standard LFM running buffer, LFM strips were photographed under ambient light and under illumination with a hand-held UV-LED flashlight.

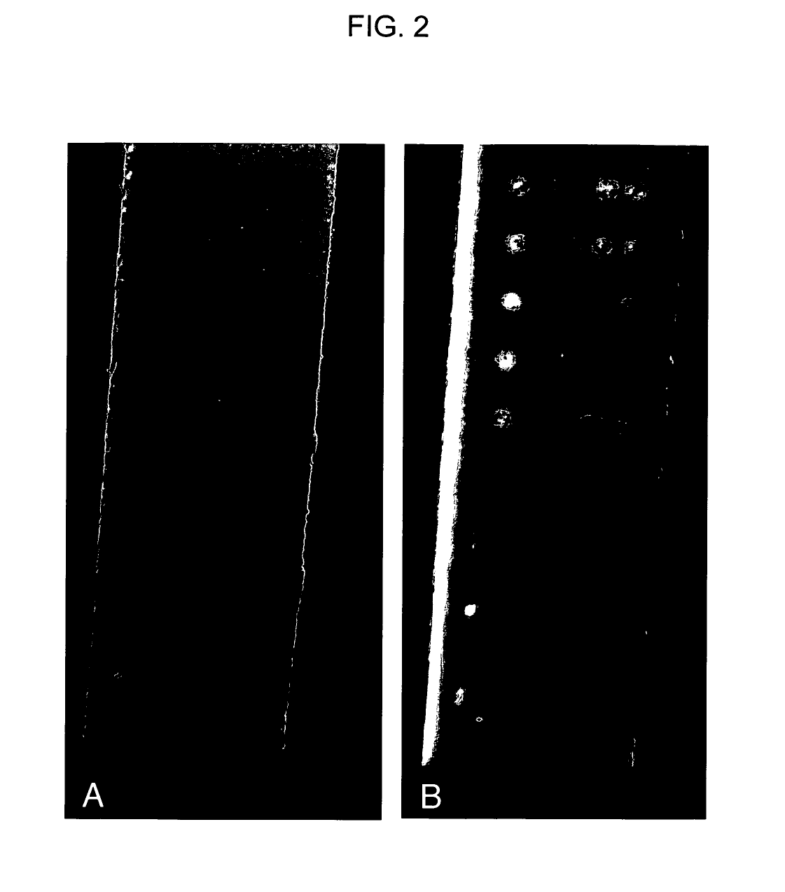

As illustrated in FIG. 2, this detection scheme clearly allows the simultaneous visualization of hybridization events using both dyed microsphere-mediated colorimetry and semiconductor nanocrystal-mediated fluorescent visualization even in the absence of optical filters. While excitation and emission filters may further benefit the sensitivity and signal-to-noise ratio exhibited, they are clearly not required for visualization of nanocrystal-based LFM signals.

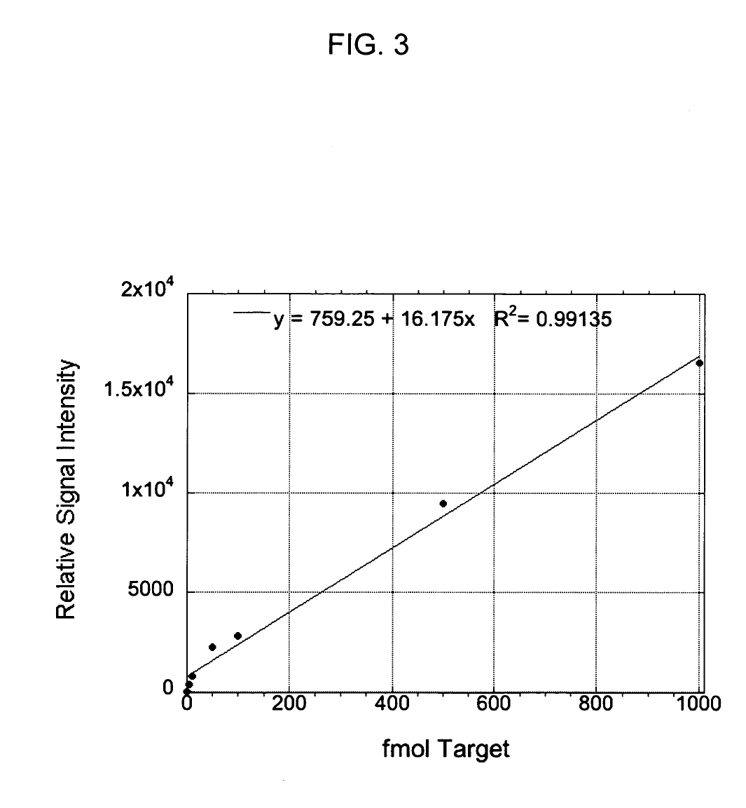

To quantify fluorescent nanocrystal LFM signal response linearity, LFMs were challenged with 1, 5, 10, 50, 100, 500, 1000 fmol of dnaR89. Following lateral flow of these samples, LFM strips were adhered to a glass microscope slide and scanned using a standard scanning laser microarray reader (GenePix 4200 Pro, Axon Instruments). A 488 nm laser was used as the excitation source. The resulting data, shown in FIG. 3, illustrate remarkable signal linearity over the 1 fmol to 1000 fmol range of dnaR89 (R²=0.991).

### Example 2

### USB-Powered CMOS Imaging Device Prototype and Used in Detecting SN-LFM Signals

To retain the advantages of SN-LFM for use in the field or in the laboratory with inexpensive instrumentation, the capacity of widely available low cost CMOS imaging systems to provide a means of detecting SN-FM signals was evaluated. Making use of a “web-cam” (Philips, FunCam DMVC300K), UV-LEDs, a gelatin filter (Kodak, WRATTEN filter #15) and an empty Altoids box (Callard & Bowser, Curiously Strong Peppermints), a simple fixed focus imaging system was fabricated for under $20. This prototype SN-LFM imaging device was energized by a USB interface, and tested for its ability to detect SN-LFM signals generated by 605 nm emission semiconductor nanocrystals (Qdots, Invitrogen, Inc.).

As shown in FIG. 4, the prototype device was able to image SN-LFM signals, without the need for complex optics. Without optimizing light distribution or image collection routines, the prototype system was readily able to detect 605 nm emissions from SN-LFM (FIG. 4C).

A more refined prototype was constructed from a digital microscope (Dino-Lite), wherein the LED light source and lens are housed in an integrated unit. This prototype has higher resolution and sensitivity, and is powered by and communicates data via a USB interface. SN-LFMs were imaged with this prototype, and compared with the results from a colorimetric LFM (FIG. 4 E-F). In this experiment, both the SN-LFM and colorimetric LFM assays were challenged with 250 amol synthetic analyte (cognate features indicated with arrows in FIG. 4E-F). As shown in FIG. 4E, the device successfully imaged the target (FIG. 4E), whereas the colorimetric assay produced only a barely detectable signal (FIG. 4F).

### LITERATURE CITATIONS

1. Huckle, D. (2006) Point-of-care diagnostics: will the hurdles be overcome this time? Expert Rev Med Devices, 3, 421-426.
2. Yang, S. and Rothman, R. E. (2004) PCR-based diagnostics for infectious diseases: uses, limitations, and future applications in acute-care settings. Lancet Infect Dis, 4, 337-348.
3. Chin, C. D., Linder, V. and Sia, S. K. (2007) Lab-on-a-chip devices for global health: past studies and future opportunities. Lab Chip, 7, 41-57.
4. Koch, W. H. (2004) Technology platforms for pharmacogenomic diagnostic assays. Nat Rev Drug Discov, 3, 749-761.
5. Mackay, I. M. (2004) Real-time PCR in the microbiology laboratory. Clin Microbiol Infect, 10, 190-212.
6. Cirino, N. M., Musser, K. A. and Egan, C. (2004) Multiplex diagnostic platforms for detection of biothreat agents. Expert Rev Mol Diagn, 4, 841-857.
Petrik, J. (2006) Diagnostic applications of microarrays. Transfus Med, 16, 233-247.
8. Heller, M. J. (2002) DNA microarray technology: devices, systems, and applications. Annu Rev Biomed Eng, 4, 129-153.
9. Peytavi, R., Raymond, F. R., Gagne, D., Picard, F. J., Jia, G., Zoval, J., Madou, M., Boissinot, K., Boissinot, M., Bissonnette, L. et al. (2005) Microfluidic device for rapid (<15 min) automated microarray hybridization. Clin Chem, 51, 1836-1844.
10. Wei, C. W., Cheng, J. Y., Huang, C. T., Yen, M. H. and Young, T. H. (2005) Using a microfluidic device for 1 microl DNA microarray hybridization in 500 s. Nucleic Acids Res, 33, e78.
11. Lim, D. V., Simpson, J. M., Kearns, E. A. and Kramer, M. F. (2005) Current and developing technologies for monitoring agents of bioterrorism and biowarfare. Clin Microbiol Rev, 18, 583-607.
12. Glynou, K., Ioannou, P. C., Christopoulos, T. K. and Syriopoulou, V. (2003) Oligonucleotide-functionalized gold nanoparticles as probes in a dry-reagent strip biosensor for DNA analysis by hybridization. Anal Chem, 75, 4155-4160.
13. Rule, G. S., Montagna, R. A. and Durst, R. A. (1996) Rapid method for visual identification of specific DNA sequences based on DNA-tagged liposomes. Clin Chem, 42, 1206-1209.
14. Dineva, M. A., Candotti, D., Fletcher-Brown, F., Allain, J. P. and Lee, H. (2005) Simultaneous visual detection of multiple viral amplicons by dipstick assay. J Clin Microbiol, 43, 4015-4021.
15. Kozwich, D., Johansen, K. A., Landau, K., Roehl, C. A., Woronoff, S. and Roehl, P. A. (2000) Development of a novel, rapid integrated Cryptosporidium parvum detection assay. Appl Environ Microbiol, 66, 2711-2717.
16. Zuiderwijk, M., Tanke, H. J., Sam Niedbala, R. and Corstjens, P. L. (2003) An amplification-free hybridization-based DNA assay to detect Streptococcus pneumoniae utilizing the up-converting phosphor technology. Clin Biochem, 36, 401-403.
17. Zijlmans, H. J., Bonnet, J., Burton, J., Kardos, K., Vail, T., Niedbala, R. S. and Tanke, H. J. (1999) Detection of cell and tissue surface antigens using up-converting phosphors: a new reporter technology. Anal Biochem, 267, 30-36.
18. Duck, P., Alvarado-Urbina, G., Burdick, B. and Collier, B. (1990) Probe amplifier system based on chimeric cycling oligonucleotides. Biotechniques, 9, 142-148.
19. Piepenburg, O., Williams, C. H., Stemple, D. L. and Armes, N. A. (2006) DNA detection using recombination proteins. PLoS Biol, 4, e204.
20. Compton, J. (1991) Nucleic acid sequence-based amplification. Nature, 350, 91-92.
21. Kievits, T., van Gemen, B., van Strijp, D., Schukkink, R., Dircks, M., Adriaanse, H., Malek, L., Sooknanan, R. and Lens, P. (1991) NASBA isothermal enzymatic in vitro nucleic acid amplification optimized for the diagnosis of HIV-1 infection. J Virol Methods, 35, 273-286.
22. Malek, L., Sooknanan, R. and Compton, J. (1994) Nucleic acid sequence-based amplification (NASBA). Methods Mol Biol, 28, 253-260.
23. Fong, W. K., Modrusan, Z., McNevin, J. P., Marostenmaki, J., Zin, B. and Bekkaoui, F. (2000) Rapid solid-phase immunoassay for detection of methicillin-resistant Staphylococcus aureus using cycling probe technology. J Clin Microbiol, 38, 2525-2529.
24. Baeumner, A. J., Schlesinger, N. A., Slutzki, N. S., Romano, J., Lee, E. M. and Montagna, R. A. (2002) Biosensor for dengue virus detection: sensitive, rapid, and serotype specific. Anal Chem, 74, 1442-1448.
25. Baeumner, A. J., Pretz, J. and Fang, S. (2004) A universal nucleic acid sequence biosensor with nanomolar detection limits. Anal Chem, 76, 888-894.
26. Hartley, H. A. and Baeumner, A. J. (2003) Biosensor for the specific detection of a single viable B. anthracis spore. Anal Bioanal Chem, 376, 319-327.
27. Zaytseva, N. V., Montagna, R. A., Lee, E. M. and Baeumner, A. J. (2004) Multi-analyte single-membrane biosensor for the serotype-specific detection of Dengue virus. Anal Bioanal Chem, 380, 46-53.
28. Edwards, K. A. and Baeumner, A. J. (2006) Optimization of DNA-tagged dye-encapsulating liposomes for lateral-flow assays based on sandwich hybridization. Anal Bioanal Chem, 386, 1335-1343.
29. Easterday, W. R., Van Ert, M. N., Simonson, T. S., Wagner, D. M., Kenefic, L. J., Allender, C. J. and Keim, P. (2005) Use of single nucleotide polymorphisms in the plcR gene for specific identification of Bacillus anthracis. J Clin Microbiol, 43, 1995-1997.
30. Easterday, W. R., Van Ert, M. N., Zanecki, S. and Keim, P. (2005) Specific detection of bacillus anthracis using a TaqMan mismatch amplification mutation assay. Biotechniques, 38, 731-735.
31. Hill, K. K., Ticknor, L. O., Okinaka, R. T., Asay, M., Blair, H., Bliss, K. A., Laker, M., Pardington, P. E., Richardson, A. P., Tonks, M. et al. (2004) Fluorescent amplified fragment length polymorphism analysis of Bacillus anthracis, Bacillus cereus, and Bacillus thuringiensis isolates. Appl Environ Microbiol, 70, 1068-1080.
32. Pannucci, J., Cai, H., Pardington, P. E., Williams, E., Okinaka, R. T., Kuske, C. R. and Cary, R. B. (2004) Virulence signatures: microarray-based approaches to discovery and analysis. Biosens Bioelectron, 20, 706-718.
33. Deiman, B., van Aarle, P. and Sillekens, P. (2002) Characteristics and applications of nucleic acid sequence-based amplification (NASBA). Mol Biotechnol, 20, 163-179.
34. Spiro, A., Lowe, M. and Brown, D. (2000) A bead-based method for multiplexed identification and quantitation of DNA sequences using flow cytometry. Appl Environ Microbiol, 66, 4258-4265.
35. Albretsen, C., Haukanes, B. I., Aasland, R. and Kleppe, K. (1988) Optimal conditions for hybridization with oligonucleotides: a study with myc-oncogene DNA probes. Anal Biochem, 170, 193-202.
36. Schildkraut, C. (1965) Dependence of the melting temperature of DNA on salt concentration. Biopolymers, 3, 195-208.
37. Blake, R. D. and Delcourt, S. G. (1996) Thermodynamic effects of formamide on DNA stability. Nucleic Acids Res, 24, 2095-2103.
38. Baeumner, A. J., Leonard, B., McElwee, J. and Montagna, R. A. (2004) A rapid biosensor for viable B. anthracis spores. Anal Bioanal Chem, 380, 15-23.
39. Guo, Z., Guilfoyle, R. A., Thiel, A. J., Wang, R. and Smith, L. M. (1994) Direct fluorescence analysis of genetic polymorphisms by hybridization with oligonucleotide arrays on glass supports. Nucleic Acids Res, 22, 5456-5465.
40. Day, P. J. R., Flora, P. S., Fox, J. E. and Walker, M. R. (1991) Immobilization of polynucleotides on magnetic particles: Factors Influencing hybridization efficiency. Biochem. J., 278, 735-740.
41. O'Meara, D., Nilsson, P., Nygren, P. A., Uhlen, M. and Lundeberg, J. (1998) Capture of single-stranded DNA assisted by oligonucleotide modules. Anal Biochem, 255, 195-203.
42. Lane, M. J., Paner, T., Kashin, I., Faldasz, B. D., Li, B., Gallo, F. J. and Benight, A. S. (1997) The thermodynamic advantage of DNA oligonucleotide ‘stacking hybridization’ reactions: energetics of a DNA nick. Nucleic Acids Res, 25, 611-617.
43. O'Meara, D., Yun, Z., Sonnerborg, A. and Lundeberg, J. (1998) Cooperative oligonucleotides mediating direct capture of hepatitis C virus RNA from serum. J Clin Microbiol, 36, 2454-2459.
44. Kandimalla, E. R., Manning, A., Lathan, C., Byrn, R. A. and Agrawal, S. (1995) Design, biochemical, biophysical and biological properties of cooperative antisense oligonucleotides. Nucleic Acids Res, 23, 3578-3584.
45. Kieleczawa, J., Dunn, J. J. and Studier, F. W. (1992) DNA sequencing by primer walking with strings of contiguous hexamers. Science, 258, 1787-1791.
46. Cheek, B. J., Steel, A. B., Torres, M. P., Yu, Y. Y. and Yang, H. (2001) Chemiluminescence detection for hybridization assays on the flow-thru chip, a three-dimensional microchannel biochip. Anal Chem, 73, 5777-5783.
47. Roper, M. G., Easley, C. J. and Landers, J. P. (2005) Advances in polymerase chain reaction on microfluidic chips. Anal Chem, 77, 3887-3893.
48. Saiki, R. K., Gelfand, D. H., Stoffel, S., Scharf, S. J., Higuchi, R., Horn, G. T., Mullis, K. B. and Erlich, H. A. (1988) Primer-directed enzymatic amplification of DNA with a thermostable DNA polymerase. Science, 239, 487-491.

All publications, patents, and patent applications cited in this specification are herein incorporated by reference as if each individual publication or patent application were specifically and individually indicated to be incorporated by reference.

The present invention is not to be limited in scope by the embodiments disclosed herein, which are intended as single illustrations of individual aspects of the invention, and any which are functionally equivalent are within the scope of the invention. Various modifications to the models and methods of the invention, in addition to those described herein, will become apparent to those skilled in the art from the foregoing description and teachings, and are similarly intended to fall within the scope of the invention. Such modifications or other embodiments can be practiced without departing from the true scope and spirit of the invention.

What is claimed is:

1. A semiconductor nanocrystal-based lateral flow microarray (SN-LFM) device for detecting the presence of at least one single-stranded target nucleic acid analyte in a fluid sample, comprising a lateral flow matrix which defines a flow path and which comprises in series:
(a) a sample receiving zone for receiving an aliquot of a fluid sample;
(b) a labeling zone in lateral flow contact with said sample receiving zone, wherein the labeling zone comprises a porous material containing at least one detection oligonucleotide reversibly bound thereto, which detection oligonucleotide is complementary to a first sequence of the target nucleic acid and is coupled to a semiconductor nanocrystal label; and,
(c) a capture zone in lateral flow contact with said labeling zone, said capture zone comprising a microporous membrane, onto which at least one capture oligonucleotide is immobilized at a feature size of 500 μm diameter or smaller.

2. The SN-LFM device of claim 1, wherein the microporous membrane is 3 mm or less in width.

3. The SN-LFM device of claim 1 wherein the sample receiving zone and the capture zone comprise a contiguous microporous membrane.

4. The SN-LFM device of claim 1, wherein the microporous membrane is a lateral flow compatible nitrocellulose membrane having a pore size of between 0.2 and 20 μm.

5. The SN-LFM device of claim 1, wherein the capture oligonucleotide is immobilized to the microporous membrane using a non-contact deposition method.

6. The SN-LFM device of claim 1, wherein the detection oligonucleotide is ligated to a dendrimeric nucleic acid molecule and not directly is coupled to a semiconductor nanocrystal label.

7. The SN-LFM device of claim 6, wherein the dendrimeric nucleic acid molecule is labeled with biotin and the semiconductor nanocrystal is coated with streptavidin.

8. A semiconductor nanocrystal-based lateral flow microarray (SN-LFM) device for detecting the presence or absence of a plurality of single-stranded target nucleic acids in one or more fluid samples, comprising a lateral flow matrix which defines a flow path and which comprises in series:
(a) a sample receiving zone for receiving the fluid sample(s);
(b) a labeling zone in lateral flow contact with said sample receiving zone, wherein the labeling zone comprises a porous material containing a plurality of different detection oligonucleotides reversibly bound thereto, which detection oligonucleotides are complementary to first sequences of a plurality of respective target nucleic acids and are coupled to differentiable semiconductor nanocrystals with different spectral emission characteristics; and,
(c) a capture zone in lateral flow contact with said labeling zone, said capture zone comprising a microporous membrane, at least a portion of which contains a plurality of different capture oligonucleotides immobilized thereto, which capture oligonucleotides are complementary to second sequences of a plurality of respective target nucleic acids, and wherein the different capture oligonucleotides are immobilized to the microporous membrane at a feature size of 300 μm or less in diameter.

9. A imaging device for collecting data from an SN-LFM assay, comprising,
(a) one or more UV LEDs for exciting a semiconductor nanocrystal label used in the SN-LFM assay,
(b) an electronic camera with a CCD or CMOS optical sensor for detecting the emission from the excited nanocrystals;
(c) an imaging platform or surface onto which SN-LFM assay detection membranes are located; and,
(d) a power and data USB interface.

10. The imaging device of claim 9, further comprising a solid state memory storage element.

11. The imaging device of claim 9, further comprising a longpass optical filter placed in front of the lens of the electronic camera.

12. The imaging device of claim 9, further comprising an SN-LFM device according to any one of claims 1-8 integrated therewith.


SEQUENCE LISTING (1 sequence)

SEQ ID NO: 1 - DNA, 35 bp, Artificial Sequence
  Oligonucleotide
aggtgagacataatcatgcatttttttttnttttn